(19) United States
(12) Patent Application Publication
(10) Pub. No.: US 2009/0235878 A1
(43) Pub. Date: Sep. 24, 2009

(54) COOLING APPARATUS OF V-TYPE INTERNAL COMBUSTION ENGINE

(75) Inventors: Tooru Kitamura, Aichi-ken (JP); Kouichi Hiratsuka, Aichi-ken (JP); Takanori Kawazu, Aichi-ken (JP); Satoshi Matsuno, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha, Toyota-shi Aichi (JP)

(21) Appl. No.: 12/307,633

(22) PCT Filed: Aug. 1, 2007
(86) PCT No.: PCT/JP2007/000828

§ 371 Date: Jan. 6, 2009

(30) Foreign Application Priority Data
Aug. 1, 2006 (JP) 2006 210199

(51) Int. Cl. F01P 5/10; F02B 75/18

(52) U.S. Cl. 123/41.44; 123/41.74

(57) ABSTRACT

In one embodiment of the present invention, a cooling water path that extends in the direction of a row of cylinders is provided between left and right banks. A communication port that communicates with a discharge port of the water pump is provided at a position on the front side between the left and right banks in the direction of the row of cylinders, and first to third and fourth to sixth introduction ports that introduce cooling water to a water jacket of the left and right banks of the cylinder block from the rear side in the direction of the row of cylinders, are formed in the cooling water path. Also, among first to fourth outlet ports 31a to 31d of a cylinder gasket 3R that correspond to each cylinder, a second outlet port 31b that is second from the front side in the direction of the row of cylinders and corresponds to a third and fourth cylinder #3 and #4 is formed with a large opening area such that an outflow volume of cooling water to left and right cylinder heads is greater for the second outlet port 31b than for third and fourth outlet ports 31c and 31d that are further to the rear in the direction of the row of cylinders and correspond to fifth to eighth cylinders #5 to #8.

### TECHNICAL FIELD

The present invention relates to a cooling apparatus of a V-type internal combustion engine in which a cylinder block is cooled by cooling water, and more specifically relates to a measure for achieving uniform temperature distribution of the cooling water in the area around a cylinder group.

### BACKGROUND ART

Ordinarily, a cooling apparatus of a V-type internal combustion engine has a cylinder block in which a row of cylinders is disposed in a V-shape, and the area around cylinder groups disposed in the left and right banks of the cylinder block is cooled by cooling water forcibly circulated by a water pump.

A conventional cooling apparatus is known (for example, see Patent Document 1) in which a cooling water path that extends in the direction of the row of cylinders is provided between the left and right banks, and provided in this cooling water path are a communication port that is in communication with a water pump discharge port at a location in the cooling water path on the front side in the direction of the row of cylinders, and a plurality of introduction ports that open at locations corresponding to each of the respective cylinders of the cylinder groups of the left and right banks, and introduce cooling water to the area around the cylinder groups. Cooling water in the cooling water path that has been supplied from the aforementioned communication port is introduced to the area around the cylinder groups of the left and right banks via the introduction ports corresponding to each cylinder of the cylinder groups, and thus the cylinder block is cooled.

### Patent Citation 1: JP-S58-107840A

### DISCLOSURE OF INVENTION

### Technical Problem

However, in the conventional technology described above, because the water pump is provided protruding to the front of the V-type internal combustion engine, the V-type internal combustion engine is long from front to rear, so a compact size cannot be achieved.

It is conceivable to achieve a compact size for the V-type internal combustion engine by housing the water pump at a position toward the front between the left and right banks.

However, in the aforementioned V-type internal combustion engine, because the water pump is provided at a position toward the front between the left and right banks, it is not possible for an introduction port that, in the area around the cylinder group of the left and right banks, introduces cooling water to the area around the cylinder at the frontmost end in the direction of the row of cylinders, to be provided in the cooling water path, and so only an introduction port that, in the area around the cylinder group of the left and right banks, introduces cooling water to the area around a cylinder toward the rear in the direction of the row of cylinders, is provided in the cooling water path. Therefore, cooling water that has been introduced via an introduction port to the area around a cylinder that is further to the rear in the direction of the row of cylinders from the inside of a V-bank in the area around the cylinder group of the left and right banks, circulates by traveling around the front side in the direction of the row of cylinders and then to the outside of the V-bank in the area around the cylinder group. However, the flow of that cooling water circulates primarily by traveling around the rear side in the direction of the row of cylinders and then to the outside of the V-bank in the area around the cylinder group, and there is a slight amount of circulation by traveling around the front side in the direction of the row of cylinders and then to the outside of the V-bank in the area around the cylinder group. Thus, a difference in the temperature distribution of the cooling water that circulates by traveling around the rear side in the direction of the row of cylinders and the cooling water that circulates by traveling around the front side in the direction of the row cylinders is unavoidable, so it is not possible to achieve uniformity of the temperature distribution of the cooling water in the area around the cylinder group.

The present invention was made in consideration of these points, and it is an object thereof to provide a cooling apparatus of a V-type internal combustion engine capable of achieving uniform temperature distribution of cooling water in the area around the cylinder group.

### Technical Solution

In order to attain the above object, in the present invention, a cooling apparatus of a V-type internal combustion engine having a cylinder block in which a row of cylinders has been disposed in a V-shape, in which the area around a cylinder group disposed in left and right banks of the cylinder block is cooled by cooling water that is forcibly circulated by a water pump, is assumed. Between the left and right banks, the water pump is provided on the front side in the direction of the row of cylinders, and a cooling water path that extends in the direction of the row of cylinders is provided to the rear of the water pump in the direction of the row of cylinders. In the cooling water path, a communication port that communicates with a discharge port of the water pump is provided at a position on the front side of the cooling water path in the direction of the row of cylinders, and an introduction port that introduces cooling water to the area around a cylinder on the rear side in the direction of the row of cylinders is provided on the inside of the V-bank in the area around the cylinder group, and outlet ports where cooling water flows out to cylinder heads are provided on the outside of the V-bank in the area around the cylinder group, the outlet ports respectively corresponding to each of the cylinder. Moreover, among the outlet ports, an outlet port that corresponds to a cylinder on the front side in the direction of the row of cylinders is set such that the outflow volume of cooling water to a cylinder head is greater for that outlet port than for an outlet port that corresponds to a cylinder on the rear side in the direction of the row of cylinders. For example, the outlet port that corresponds to a cylinder on the front side in the direction of the row of cylinders is formed so as to have a larger opening area than that of the outlet port that corresponds to a cylinder on the rear side in the direction of the row of cylinders.

According to this feature, a compact size is achieved for the V-type internal combustion engine by providing the water pump between the left and right banks. In this case, among the outlet ports where cooling water flows out to cylinder heads, the outlet ports provided on the outside of the V-bank in the area around the cylinder group and corresponding to each cylinder, an outlet port that corresponds to a cylinder on the front side in the direction of the row of cylinders is set such that the outflow volume of cooling water to a cylinder head is greater for that outlet port than for an outlet port that corresponds to a cylinder on the rear side in the direction of the row of cylinders. Thus, the outflow volume of cooling water is larger from the outlet port that corresponds to a cylinder on the front side in the direction of the row of cylinders, so the cooling water can easily circulate from the inside of the V-bank in the area around the cylinder group to the outside of the V-bank by traveling around the front side in the direction of the row of cylinders, although cooling water that has been introduced from inside of the V-bank in the area around the cylinder group of the left and right banks via an introduction port of the cooling water path is introduced from the area around the cylinder group of the left and right banks from the rear side in the direction of the row of cylinders. Thus, inside the V-bank in the area around the cylinder group of the left and right banks, the flow of cooling water that has been introduced to the area around a cylinder on the rear side in the direction of the row of cylinders via the introduction port is prevented from easily circulating to the outside of the V-bank in the area around the cylinder group primarily by traveling around the rear side in the direction of the row of cylinders, and so a sufficient amount of cooling water circulation to the outside of the V-bank in the area around the cylinder group by traveling around the front side in the direction of the row of cylinders can be insured for the cooling water that has been introduced via the introduction port. Thus, a difference in the temperature distribution between the cooling water that circulates by traveling around the rear side in the direction of the row of cylinders and the cooling water that circulates by traveling around the front side in the direction of the row of cylinders is suppressed, so it is possible to achieve uniform temperature distribution of the cooling water in the area around the cylinder group.

Furthermore, by setting the configuration such that the outflow volume from an outlet port that corresponds to a cylinder that is toward the front in the direction of the row of cylinders is greater than the outflow volume from an outlet port that corresponds to a cylinder that is toward the rear in the direction of the row of cylinders, the flow volume of cooling water that circulates in a short outflow path by traveling around the front side in the direction of the row of cylinders increases for the outlet port that corresponds to a cylinder that is toward the front in the direction of the row of cylinders. Additionally, by suppressing the flow volume of cooling water that circulates in a long outflow path by traveling around the rear side in the direction of the row of cylinders for the outlet port that corresponds to a cylinder that is toward the front in the direction of the row of cylinders, it is possible to suppress pressure loss of the water pump.

Also, when a cylinder head gasket is provided between the cylinder block and the cylinder head, and the outlet ports are respectively provided at corresponding locations of the cylinder head gasket that correspond to each cylinder on the outside of the V-bank in the area around the cylinder group, merely by providing outlet ports of varying size at the corresponding positions of the cylinder head gasket, it is possible to easily set a configuration such that the outflow volume is greater from the outlet port that corresponds to a cylinder toward the front in the direction of the row of cylinders.

### ADVANTAGEOUS EFFECTS

In summary, by setting, among the outlet ports where cooling water flows out to cylinder heads, an outlet port that corresponds to a cylinder on the front side in the direction of the row of cylinders such that the outflow volume of cooling water to a cylinder head is greater for that outlet port than for an outlet port that corresponds to a cylinder on the rear side in the direction of the row of cylinders, a sufficient amount of cooling water circulation to the outside of the V-bank in the area around the cylinder group by traveling around the front side in the direction of the row of cylinders is insured. Thus, a difference in the temperature distribution between the cooling water that circulates by traveling around the rear side in the direction of the row of cylinders and the cooling water that circulates by traveling around the front side in the direction of the row of cylinders is suppressed, so it is possible to achieve uniform temperature distribution of the cooling water in the area around the cylinder group. Moreover, by increasing the flow volume of cooling water that circulates in a short outflow path by traveling around the front side in the direction of the row of cylinders for an outlet port that corresponds to a cylinder that is on the front side in the direction of the row of cylinders, that outlet port having a high flow volume to the cylinder head, and also suppressing the flow volume of cooling water that circulates in a long outflow path by traveling around the rear side in the direction of the row of cylinders, it is possible to suppress pressure loss of the water pump.

### BRIEF DESCRIPTION OF THE DRAWINGS

FIG. 1 shows the general configuration of the inside of an engine, in which a V-type engine employing a cooling apparatus according to an embodiment of the present invention, viewed from the front side in an axial direction of a crank shaft.

FIG. 2 is a plane view in which a cylinder block of the V-type engine is viewed from above.

FIG. 3 schematically shows the configuration of the cooling apparatus.

FIG. 4 is a plane view of a cylinder head gasket of a right-side bank.

### EXPLANATION OF REFERENCE

1 V-type engine (V-type internal combustion engine)
3R cylinder head gasket
10L left bank
10R right bank
11 cylinder block
14 crank shaft
20 water pump
202 discharge port
21L water jacket of left-side bank (area around cylinder group)
21R water jacket of right-side bank (area around cylinder group)
22 cooling water path
221 communication port
222a to 222c first to third introduction ports of left-side bank
222d to 222f fourth to sixth introduction ports of right-side bank
31b second introduction port corresponding to second cylinder from front side in direction of row of cylinders
31c, 31d third and fourth introduction ports corresponding to cylinders on rear side in direction of row of cylinders

### BEST MODE FOR CARRYING OUT THE INVENTION

Hereinafter, an embodiment of the present invention will be described with reference to the drawings. In this embodiment, a case will be described in which a cooling apparatus according to the present invention has been applied to an automobile V-type 8-cylinder engine (a V-type internal combustion engine).

Overall Configuration of Engine

A description of the cooling apparatus will be preceded by a description of the overall configuration of an engine equipped with this cooling apparatus.

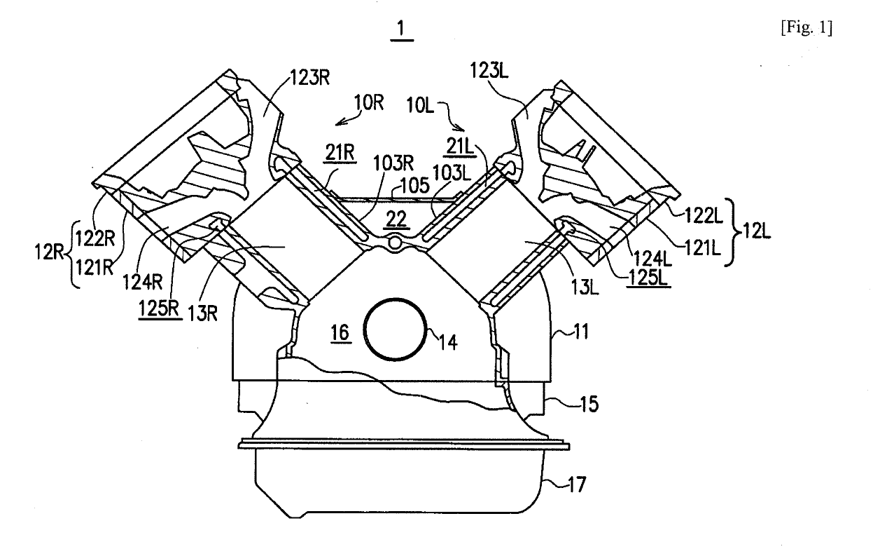

FIG. 1 shows the general configuration of the inside of the engine, in which a V-type engine 1 according to the present embodiment is viewed from the axial direction of a crank shaft 14. As shown in FIG. 1, the V-type engine 1 has a pair of left and right banks 10L and 10R that protrude in a V-shape in the upper portion of a cylinder block 11. The banks 10L and 10R are provided with cylinder heads 12L and 12R disposed in the upper end portion of the cylinder block 11. A plurality of cylinders 13L, 13R, . . . (for example, four cylinders in each of the banks 10L and 10R) are disposed at a predetermined angle relative to each other (for example, 90 degrees between the banks 10L and 10R). Pistons are housed inside these cylinders 13L, 13R, . . . , such that the pistons can move back and forth, and each piston is linked to the crank shaft 14 via a connecting rod so as to be capable of transmitting driving force. Furthermore, a crank case 15 is installed on the bottom side of the cylinder block 11, and a space spanning from the lower portion of the inside of the cylinder block 11 to the inside of the crank case 15 forms a crank room 16. Also, an oil pan 17 is provided on the bottom side of the crank case 15. In the case of the present embodiment, the crank shaft 14 is provided extending in the direction from front to rear of a vehicle body, and the V-type engine 1 is mounted vertically in the front portion of the vehicle body.

Also, the cylinder heads 12L and 12R of the V-type engine 1 have a divided structure. Specifically, the cylinder heads 12L and 12R are configured from cylinder head bodies 121L and 121R installed on the upper face of the cylinder block 11, and camshaft housings 122L and 122R installed on the top side of the cylinder head bodies 121L and 121R. Also, intake ports 123L, 123R, . . . , are provided on the inside of the cylinder heads 12L and 12R, and exhaust ports 124L, 124R, . . . , are provided on the outside.

Cooling Apparatus

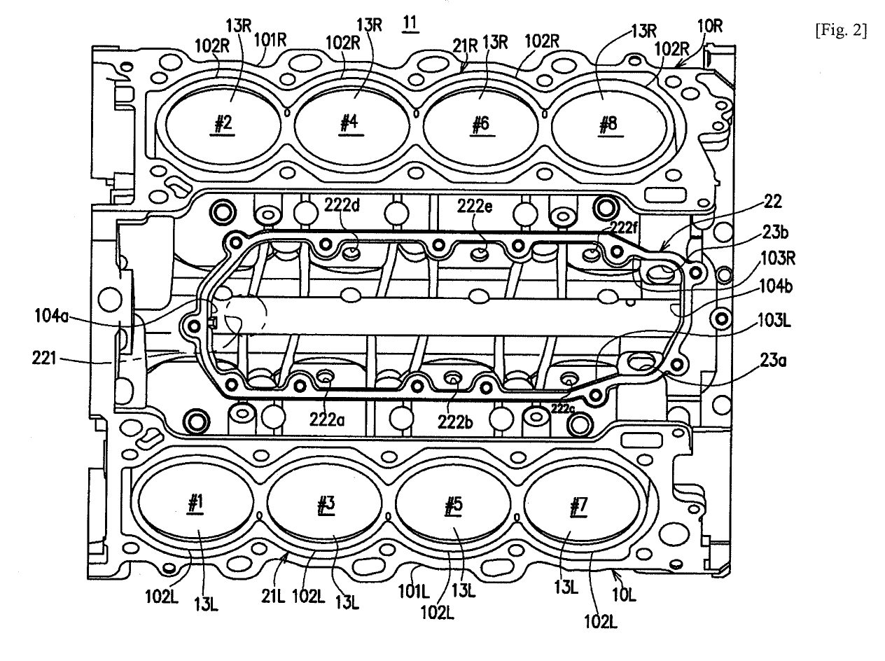

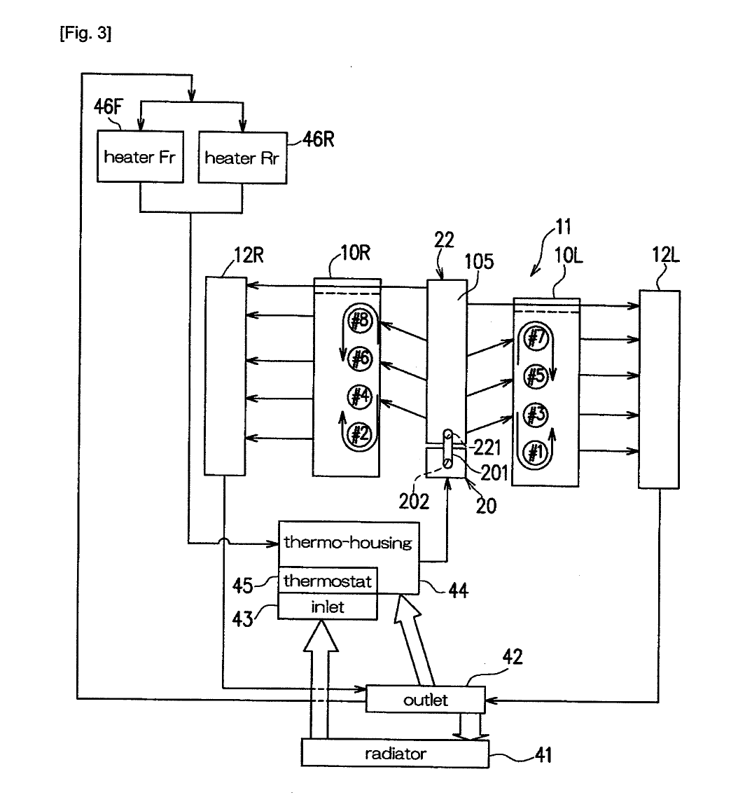

Next is a description of the cooling apparatus, which supplies cooling water to the aforementioned left and right banks 10L and 10R of the cylinder block 11, and cylinder heads 12L and 12R, with reference to FIGS. 2 and 3.

FIG. 2 is a plane view in which the cylinder block 11 of the V-type engine 1 of the present embodiment is viewed from above, and FIG. 3 schematically shows the configuration of a cooling system 2. Here, in FIG. 2, a row of odd-numbered cylinders is disposed in the bank 10L on the left side (the bank on the bottom side in FIG. 2), and a row of even-numbered cylinders is disposed in the bank 10R on the right side (the bank on the top side in FIG. 2). In the description of the row of cylinders in the left-side bank 10L, the cylinder located on the front end in the direction of that row of cylinders (the left end in FIG. 2) is denoted as a first cylinder #1, the cylinder located to the rear of the first cylinder #1 (on the right side in FIG. 2) is denoted as a third cylinder #3, the cylinder located to the rear of the third cylinder #3 (on the right side in FIG. 2) is denoted as a fifth cylinder #5, and the cylinder located on the rear end (on the right end in FIG. 2) is denoted as a seventh cylinder #7. On the other hand, in the description of the row of cylinders in the right-side bank 10R, the cylinder located on the front end in the direction of that row of cylinders (the left end in FIG. 2) is denoted as a second cylinder #2, the cylinder located to the rear of the second cylinder #2 (on the right side in FIG. 2) is denoted as a fourth cylinder #4, the cylinder located to the rear of the fourth cylinder #4 (on the right side in FIG. 2) is denoted as a sixth cylinder #6, and the cylinder located on the rear end (on the right end in FIG. 2) is denoted as an eighth cylinder #8. Note that the form of the cylinder numbers is not limited to the form given above.

The cylinder block 11 is formed as an open deck-type cylinder block. That is, water jackets 21L and 21R are open at the top face (the side of the cylinder heads 12L and 12R) of the left and right banks 10L and 10R of the cylinder block 11. The water jackets 21L and 21R are formed between outer walls 101L and 101R of the respective banks 10L and 10R of the cylinder block 11, and respective cylinder walls 102L, 102R, . . . , so as to enclose approximately the entire circumference of the cylinders 13L, 13R, . . . , of the left and right banks 10L and 10R.

A water pump 20 (shown in FIG. 3) driven with rotational force from the crank shaft is provided at a front side position between the left and right banks 10L and 10R of the cylinder block 11. Also, a cooling water path 22 that extends in the direction of the row of cylinders (the left-right direction in FIG. 2) is provided between the left and banks 10L and 10R of the cylinder block 11. The cooling water path 22 is partitioned as a single body by inner walls 103L and 103R of the banks 10L and 10R of the cylinder block 11, and front and rear shielding ribs 104a and 104b that shield both the front and the rear end of the inner walls 103L and 103R, and is covered from above by a lid 105 (shown in FIG. 1) so as to maintain a tightly closed state. The cooling water path 22 is located between the left and right banks 10L and 10R, from the rear side of where the water pump 20 is located on the front side between the left and right banks 10L and 10R, to the rear end of the cylinder block 11.

As shown in FIG. 3, a communication port 221 that communicates with a discharge port 202 of the water pump 20 is provided in the cooling water path 22, at a position toward the front of the cooling water path 22 in the direction of the row of cylinders. The communication port 221 is open to a front end portion of the lid 105, and communicates with the discharge port 202 of the water pump 20 via a pipe 201 formed as a single body with the front end portion of the lid 105. Cooling water that has been discharged from the discharge port 202 of the water pump 20 is supplied from the communication port 221 to the front end portion of the cooling water path 22 via the pipe 201.

Also, as shown in FIG. 2, first to third introduction ports 222a to 222c that introduce cooling water to the water jacket 21L of the left-side bank 10L of the cylinder block 11 are formed at three corresponding locations of the inner wall 103L that respectively correspond to cylinders toward the rear in the direction of the row of cylinders of the left-side bank 10L of the cooling water path 22, for example the third, fifth, and seventh cylinders #3, #5, and #7. Cooling water that has been introduced from the first to third introduction ports 222a to 222c is introduced from the inside of the V-bank of the water jacket 21L of the left-side bank 10L (the top side in FIG. 2), circulates from the inside of the V-bank of the water jacket 21L of the left-side bank 10L to the outside of the V-bank (the bottom side in FIG. 2), by traveling around the front side in the direction of the row of cylinders, and circulates to the outside of the V-bank by traveling around the rear side in the direction of the row of cylinders. Also, fourth to sixth introduction ports 222d to 222f that introduce cooling water to the water jacket 21R of the right-side bank 10R of the cylinder block 11 are formed at three corresponding locations of the inner wall 103R that respectively correspond to cylinders toward the rear in the direction of the row of cylinders of the right-side bank 10R of the cooling water path 22, for example the fourth, sixth, and eighth cylinders #4, #6, and #8. Cooling water that has been introduced from the fourth to sixth introduction ports 222d to 222f is introduced from the inside of the V-bank of the water jacket 21R of the right-side bank 10R (the bottom side in FIG. 2), circulates from the inside of the V-bank of the water jacket 21R of the right-side bank 10R to the outside of the V-bank (the top side in FIG. 2), by traveling around the front side in the direction of the row of cylinders, and circulates to the outside of the V-bank by traveling around the rear side in the direction of the row of cylinders. In this case, because the water pump 20 is provided at a location on the front side between the left and right banks 10L and 10R, the front end of the cooling water path 22 approximately corresponds to the cylinder at the front in the direction of the row of cylinders in the left-side bank 10L (for example, the first cylinder #1) and the cylinder at the front in the direction of the row of cylinders in the right-side bank 10R (for example, the second cylinder #2). Therefore, in this configuration it is not possible to form introduction ports at corresponding positions of the inner walls 103L and 103R that respectively correspond to the first cylinder #1 at the frontmost end in the direction of the row of cylinders in the left-side bank 10L and the second cylinder #2 at the frontmost end in the direction of the row of cylinders in the right-side bank 10R.

Moreover, in a rear end portion in the direction of the row of cylinders of the cooling water path 22, cooling water supply ports 23a and 23b are formed that respectively supply cooling water to the left and right cylinder heads 12L and 12R from the rear end portion in the direction of the row of cylinders of the cooling water path 22. As shown in FIG. 1, cooling water supplied from the cooling water supply ports 23a and 23b is supplied into the left and right cylinder heads 12L and 12R respectively from a rear end portion of water jackets 125L and 125R that extend in the direction of the row of cylinders, and cooling water that has circulated in the water jackets 125L and 125R is guided outside (toward the front of the vehicle body) from the front end portion of the cylinder heads 12L and 12R.

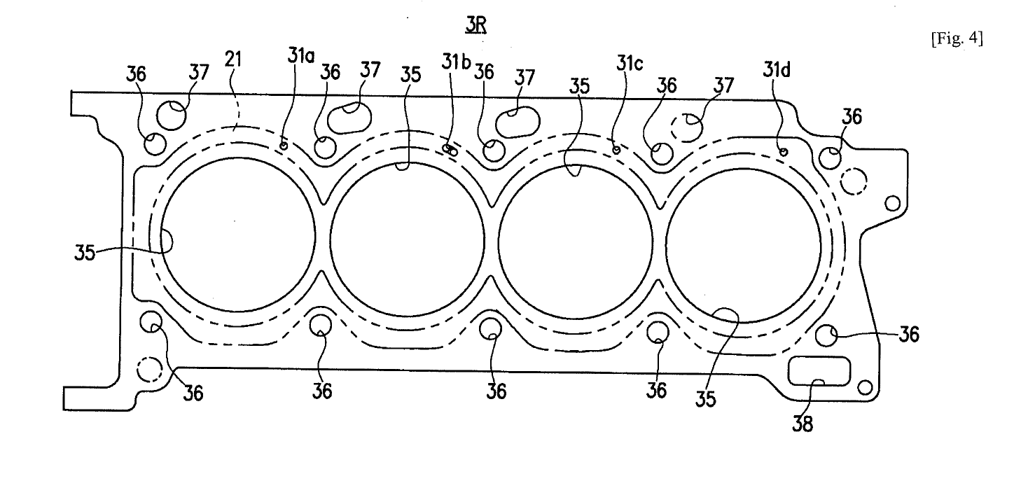

Also, a cylinder head gasket 3R as shown in FIG. 4 is provided respectively between the top face of the left and right banks 10L and 10R of the cylinder block 11 and the bottom face of the cylinder head bodies 121L and 121R of the left and right cylinder heads 12L and 12R (FIG. 4 shows only the cylinder head gasket 3R provided between the top face of the right-side bank 10R of the cylinder block 11 and the bottom face of the cylinder head body 121R of the right-side cylinder head 12R). Also, at corresponding positions of the cylinders #1 to #8 of the cylinder head gasket 3R where the outside of the V-bank of the water jackets 21L and 21R of the left and right banks 10L and 10R, and the water jackets 125L and 125R of the left and right cylinder heads 12L and 12R, face each other, first to fourth outlet ports 31a, 31b, 31c, and 31d are formed in order from the front side in the direction of the row of cylinders. The first to fourth outlet ports 31a, 31b, 31c, and 31d guide cooling water from the water jackets 21L and 21R of the left and right banks 10L and 10R of the cylinder block 11 to the water jackets 125L and 125R of the left and right cylinder heads 12L and 12R. The second outlet port 31b, which is second from the front side in the direction of the row of cylinders among the outlet ports 31a to 31d and corresponds respectively to the third cylinder #3 and the fourth cylinder #4, is set such that the outflow volume of cooling water to the left and right cylinder heads 12L and 12R is greater for the second outlet port 31b than for the third and fourth outlet ports 31c and 31d, which are further to the rear in the direction of the row of cylinders and correspond to the fifth to eighth cylinders #5 to #8. Specifically, the second outlet port 31b of the cylinder head gasket 3R, which is second from the front side in the direction of the row of cylinders and corresponds respectively to the third cylinder #3 and the fourth cylinder #4, is formed such that the opening area of the second outlet port 31b is larger than the opening area of the third and fourth outlet ports 31c and 31d of the cylinder head gasket 3R, which are further to the rear in the direction of the row of cylinders and correspond to the fifth to eighth cylinders #5 to #8. Also, in the cylinder head gasket 3R, four combustion chamber holes 35 are formed that match the cylinders 13R of the cylinder block 11, and a plurality of bolt holes 36 are formed where fastening bolts pass through, the fastening bolts fastening the left and right banks 10L and 10R of the cylinder block 11 to the cylinder heads 12L and 12R. Also note that in FIG. 4, reference numerals 37 denote oil return holes for returning oil provided in the cylinder head gasket 3R, and reference number 38 denotes a water hole through which cooling water flows.

In this case, the second outlet port 31b of the cylinder head gasket 3R, which is second from the front side in the direction of the row of cylinders and corresponds respectively to the third cylinder #3 and the fourth cylinder #4, is formed such that the opening area of the second outlet port 31b is larger than the opening area of the third and fourth outlet ports 31c and 31d of the cylinder head gasket 3R, which are further to the rear in the direction of the row of cylinders and correspond to the fifth to eighth cylinders #5 to #8. Thus, with respect to the cooling water that has been introduced from the first to third introduction ports 222a to 222c, which correspond respectively to the third, fifth, and seventh cylinders #3, #5, and #7, and the cooling water that has been introduced from the fourth to sixth introduction ports 222d to 222f, which correspond respectively to the fourth, sixth, and eighth cylinders #4, #6, and #8, which are to the rear in the direction of the row of cylinders of the left and right banks 10L and 10R of the cooling water path 22, the outflow volume of cooling water is larger from the second outlet port 31b, which is toward the front side in the direction of the row of cylinders of the cylinder head gasket 3R, to the cylinder heads 12L and 12R, and so the cooling water can easily circulate from the inside of the V-bank of the water jackets 21L and 21R of the left and right banks 10L and 10R to the outside of the V-bank by traveling around the front side in the direction of the row of cylinders, although the location of introduction of cooling water to the inside of the V-bank of the water jackets 21L and 21R of the left and right banks 10L and 10R is to the rear in the direction of the row of cylinders. Also, the first outlet port 31a of the cylinder head gasket 3R, which is frontmost end in the direction of the row of cylinders among the outlet ports 31a to 31d and corresponds to the first and second cylinders #1 and #2, is formed with about the same opening area as the third and fourth outlet ports 31c and 31d of the cylinder head gasket 3R, which are to the rear in the direction of the row of cylinders and correspond to the fifth to eighth cylinders #5 to #8.

The cooling water that has circulated from the inside of the V-bank of the water jackets 21L and 21R of the left and right banks 10L and 10R of the cylinder block 11 to the outside of the V-bank by traveling around the front side in the direction of the row of cylinders and the rear side in the direction of the row of cylinders, at the outside of the V-bank, flows out to the water jackets 125L and 125R of the left and right cylinder heads 12L and 12R from the first to fourth outlet ports 31a to 31d, cools the left and right cylinder heads 12L and 12R by circulating with cooling water that has been supplied to the water jackets 125L and 125R of the left and right cylinder heads 12L and 12R from the cooling water supply ports 23a and 23b of the cooling water path 22, and is guided out from the front end portion of the left and right cylinder heads 12L and 12R respectively to outside (toward the front of the vehicle body).

Following is a description of the overall configuration of the cooling apparatus with reference to FIG. 3.

An air-cooled radiator 41 is provided to the front of the V-type engine 1. Cooling water that has been guided outside from the front end portion of the cylinder heads 12L and 12R is guided into the radiator 41 via an outlet housing 42. Cooling water that has been cooled by the radiator 41 is guided out from an inlet housing 43 to the water pump 20 via a thermo-housing 44. Also guided out to the water pump 20 via the thermo-housing 44 is cooling water from the left and right cylinder heads 12L and 12R that has been guided out to the outlet housing 42. Provided within the thermo-housing 44 is a thermostat 45 that operates according to the temperature of the cooling water that has been guided out to the thermo-housing 44 via the inlet housing 43. When the temperature of cooling water that has been guided out to the thermo-housing 44 from the radiator 41 via the inlet housing 43 is not more than a predetermined temperature (for example, 80 to 90 degrees C.), guiding out of cooling water from the radiator 41 to the thermo-housing 44 via the inlet housing 43 is prohibited by the thermostat 45, and cooling water from the left and right cylinder heads 12L and 12R that has been guided out to the outlet housing 42 is guided to the water pump 20 via the thermo-housing 44 so that the V-type engine 1 is warmed up. On the other hand, when the temperature of cooling water that has been guided out to the thermo-housing 44 from the radiator 41 via the inlet housing 43 is more than the predetermined temperature, the cooling water from the left and right cylinder heads 12L and 12R that has been guided out to the outlet housing 42 is cooled in the radiator 41 according to the thermostat 45. The cooling water that has been cooled in the radiator 41 is guided out to the thermo-housing 44 via the inlet housing 43, and then guided out to the water pump 20. Thus, cooling of the V-type engine 1 is performed by cooling water from the radiator 41.

Also, cooling water from the left and right cylinder heads 12L and 12R that has been guided out to the outlet housing 42 is respectively supplied to front rear vehicle cabin heaters 46F and 46R to heat both heaters 46F and 46R, and then that cooling water is guided out to the thermo-housing 44 without passing through the thermostat 45.

Accordingly, in the above embodiment, a more compact size is achieved for the V-type engine 1 by providing the water pump 20 between the left and right banks 10L and 10R.

In this case, among the first to fourth outlet ports 31a to 31d, which are formed at positions of the cylinder head gasket 3R and a cylinder head gasket 3L (not shown) corresponding to the cylinders #1 to #8 where the outside of the V-bank of the water jackets 21L and 21R of the left and right banks 10L and 10R, and the water jackets 125L and 125R of the left and right cylinder heads 12L and 12R, face each other, the respective first to fourth outlet ports 31a to 31d being where cooling water from the water jackets 21L and 21R of the left and right banks 10L and 10R of the cylinder block flows out to the water jackets 125L and 125R of the left and right cylinder heads 12L and 12R, the second outlet port 31b, which is second from the front side in the direction of the row of cylinders and corresponds respectively to the third cylinder #3 and the fourth cylinder #4, is formed with an increased opening area such that the outflow volume of cooling water to the left and right cylinders 12L and 12R is greater from the second outlet port 31b than from the third and fourth outlet ports 31c and 31d, which are further to the rear in the direction of the row of cylinders and correspond to the fifth to eighth cylinders #5 to #8. Thus, with respect to the cooling water that has been introduced from the first to third introduction ports 222a to 222c, which correspond respectively to the third, fifth, and seventh cylinders #3, #5, and #7, and the cooling water that has been introduced from the fourth to sixth introduction ports 222d to 222f, which correspond respectively to the fourth, sixth, and eighth cylinders #4, #6, and #8, which are to the rear in the direction of the row of cylinders of the left and right banks 10L and 10R of the cooling water path 22, the outflow volume of cooling water is larger from the second outlet port 31b, which is toward the front side in the direction of the row of cylinders of the cylinder head gasket 3R, to the cylinder heads 12L and 12R, and so the cooling water can easily circulate from the inside of the V-bank of the water jackets 21L and 21R of the left and right banks 10L and 10R of the cylinder block 11 to the outside of the V-bank by traveling around the front side in the direction of the row of cylinders, although the location of introduction of cooling water to the inside of the V-bank of the water jackets 21L and 21R of the left and right banks 10L and 10R is to the rear in the direction of the row of cylinders. Thus, the flow of cooling water that has been introduced inside the V-bank of the water jackets 21L and 21R of the left and right banks 10L and 10R of the cylinder block 11 via the first to sixth introduction ports 222a to 222c and 222d to 222f is prevented from easily circulating to the outside of the V-bank primarily by traveling around the rear side in the direction of the row of cylinders of the water jackets 21L and 21R, and so a sufficient amount of circulation to the outside of the V-bank by traveling around the front side in the direction of the row of cylinders of the water jackets 21L and 21R of the left and right banks 10L and 10R can be insured for the cooling water that has been introduced inside the V-bank of the water jackets 21L and 21R. Thus, a difference in the temperature distribution between the cooling water that circulates by traveling around the rear side in the direction of the row of cylinders and the cooling water that circulates by traveling around the front side in the direction of the row of cylinders is suppressed, so it is possible to achieve uniform temperature distribution of the cooling water in the water jackets 21L and 21R of the left and right banks 10L and 10R.

Furthermore, the second outlet port 31b, which is second from the front side in the direction of the row of cylinders and corresponds respectively to the third cylinder #3 and the fourth cylinder #4, is formed with an increased opening area such that the outflow volume of cooling water from the second outlet port 31b is greater than the outflow volume of the third and fourth outlet ports 31c and 31d, which are further to the rear in the direction of the row of cylinders and correspond to the fifth to eighth cylinders #5 to #8. Thus, the flow volume of cooling water that circulates in a short outflow path by traveling around the front side in the direction of the row of cylinders increases for the second outlet port 31b, which is second from the front side in the direction of the row of cylinders and corresponds respectively to the third cylinder #3 and the fourth cylinder #4, and has a large outflow volume to the water jackets 125L and 125R of the cylinder heads 12L and 12R. Additionally, by suppressing the flow volume of cooling water that circulates in a long outflow path by traveling around the rear side in the direction of the row of cylinders for the second outlet port 31b, it is possible to suppress pressure loss of the water pump 20.

Also, the first to fourth outlet ports 31a to 31d are provided at corresponding positions of the cylinders #1 to #8 of the cylinder head gasket 3R where the outside of the V-bank of the water jackets 21L and 21R of the left and right banks 10L and 10R, and the water jackets 125L and 125R of the left and right cylinder heads 12L and 12R, face each other. Thus, merely by forming the first to fourth outlet ports 31a to 31d of varying size at the corresponding positions of the cylinder head gasket 3R, it is possible to easily set a configuration such that the outflow volume is greater for the second outlet port 31b, which is second from the front side in the direction of the row of cylinders and corresponds respectively to the third cylinder #3 and the fourth cylinder #4.

Also, the present invention is not limited to the embodiment described above, and encompasses various modifications thereof. For example, in the above embodiment, a cooling apparatus of the V-type 8-cylinder engine 1 is described, but the present invention is applicable as a cooling apparatus of any V-type engine, such as a V-type 6-cylinder engine, a V-type 10-cylinder engine, or a V-type 12-cylinder engine.

Also, in the above embodiment, the second outlet port 31b, which is second from the front side in the direction of the row of cylinders and corresponds respectively to the third cylinder #3 and the fourth cylinder #4, is formed with an increased opening area such that the outflow volume of cooling water is greater for the second outlet port 31b than for the third and fourth outlet ports 31c and 31d, which are further to the rear in the direction of the row of cylinders and correspond to the fifth to eighth cylinders #5 to #8. However, in order to set the same outflow volume of cooling water that circulates from the inside of the V-bank of the water jackets of the left and right banks of the cylinder block to the outside of the V-bank by traveling around the front side in the direction of the row of cylinders and the rear side in the direction of the row of cylinders, a configuration may be adopted in which the first outlet port, which is frontmost in the direction of the row of cylinders and corresponds respectively to the first cylinder and the second cylinder, is formed with an increased opening area such that the outflow volume of cooling water is greater for the first outlet port than for the second to fourth outlet ports, which are further to the rear in the direction of the row of cylinders and correspond to the third to eighth cylinders, or a configuration may be adopted in which the first and second outlet ports, which are frontmost in the direction of the row of cylinders and correspond respectively to the first to fourth cylinders, are formed with an increased opening area such that the outflow volume of cooling water is greater for the first and second outlet ports than for the third and fourth outlet ports, which are further to the rear in the direction of the row of cylinders and correspond to the fifth to eighth cylinders.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

This application claims priority on Japanese Patent Application No. 2006-210199 filed in Japan on Aug. 1, 2006, the entire contents of which are hereby incorporated by reference. Furthermore, the entire contents of references cited in the present description are hereby specifically incorporated by reference.

1. A cooling apparatus of a V-type internal combustion engine having a cylinder block in which a row of cylinders has been disposed in a V-shape, in which the area around a cylinder group disposed in left and right banks of the cylinder block is cooled by cooling water that is forcibly circulated by a water pump, wherein:
between the left and right banks, the water pump is provided on the front side in the direction of the row of cylinders, and a cooling water path that extends in the direction of the row of cylinders is provided to the rear of the water pump in the direction of the row of cylinders; and in the cooling water path,
a communication port that communicates with a discharge port of the water pump is provided at a position on the front side of the cooling water path in the direction of the row of cylinders, and an introduction port that introduces cooling water to the area around a cylinder on the rear side in the direction of the row of cylinders is provided on the inside of the V-bank in the area around the cylinder group, and
outlet ports where cooling water flows out to cylinder heads are provided on the outside of the V-bank in the area around the cylinder group, the outlet ports respectively corresponding to each of the cylinder; wherein
among the outlet ports, an outlet port that corresponds to a cylinder on the front side in the direction of the row of cylinders is set such that the outflow volume of cooling water to a cylinder head is greater for that outlet port than for an outlet port that corresponds to a cylinder on the rear side in the direction of the row of cylinders.

2. The cooling apparatus of a V-type internal combustion engine according to claim 1, wherein
the outlet port that corresponds to a cylinder on the front side in the direction of the row of cylinders is formed so as to have a larger opening area than that of the outlet port that corresponds to a cylinder on the rear side in the direction of the row of cylinders.

3. The cooling apparatus of a V-type internal combustion engine according to claim 1, wherein
a cylinder head gasket is provided between the cylinder block and the cylinder head; and
the outlet ports are respectively provided on the outside of the V-bank in the area around the cylinder group, at corresponding positions of the cylinder head gasket that correspond to each cylinder.

4. The cooling apparatus of a V-type internal combustion engine according to claim 2, wherein
a cylinder head gasket is provided between the cylinder block and the cylinder head; and
the outlet ports are respectively provided on the outside of the V-bank in the area around the cylinder group, at corresponding positions of the cylinder head gasket that correspond to each cylinder.
